(19) United States
(12) Patent Application Publication
(10) Pub. No.: US 2026/0328114 A1
(43) Pub. Date: Oct. 22, 2026

(54) INSULATION ASSEMBLY FOR A GAS TURBINE EXHAUST DIFFUSER

(71) Applicant: GE Vernova Infrastructure Technology LLC, Greenville, SC (US)

(72) Inventors: Robert JAMIOLKOWSKI, Warszawa (PL); Robert Jacek ZREDA, Warszawa (PL)

(21) Appl. No.: 19/645,656

(22) Filed: Apr. 13, 2026

(30) Foreign Application Priority Data
Apr. 18, 2025 (PL) P.451837

(51) Int. Cl. F01D 25/14; F01D 25/30

(52) U.S. Cl. CPC F01D 25/145; F01D 25/30

(57) ABSTRACT

An insulation assembly is affixed to a turbomachine component. The insulation assembly includes at least one pin that is fixedly coupled to the turbomachine component. The at least one pin includes a pin body and a disk that is coupled to the pin body. The insulation assembly further includes at least one washer that surrounds the pin body and is movable relative to the at least one pin. The at least one washer includes a central body and a plurality of lobe members that extend from the central body. The insulation assembly further includes an insulation panel that is disposed between the at least one washer and the turbomachine component. The insulation panel surrounds the pin body, and the insulation panel is movable between the at least one washer and the turbomachine component relative to the at least one pin and relative to the turbomachine component.

### CROSS-REFERENCE TO RELATED APPLICATION

This application claims priority pursuant to 35 U.S.C. 119(a) to Polish Patent Application No. P.451837, filed Apr. 18, 2025, which application is incorporated herein by reference in its entirety.

### TECHNICAL FIELD

The present disclosure relates generally to an insulation assembly for a gas turbine exhaust diffuser. Specifically, the present disclosure relates to an insulation assembly having at least one washer with a plurality of lobe members.

### BACKGROUND

Turbomachines are utilized in a variety of industries and applications for energy transfer purposes. For example, a gas turbine engine generally includes a compressor section, a combustion section, a turbine section (e.g., an expansion turbine), and an exhaust section. The compressor section progressively increases the pressure of a working fluid entering the gas turbine engine and supplies this compressed working fluid to the combustion section. The compressed working fluid and a fuel (e.g., natural gas) mix within the combustion section and burn in a combustion chamber to generate high pressure and high temperature combustion gases. The combustion gases flow from the combustion section into the turbine section where they expand to produce work. For example, expansion of the combustion gases in the turbine section may rotate a rotor shaft connected, e.g., to a generator to produce electricity. The combustion gases are then exhausted from the turbine section through an exhaust diffuser positioned downstream from the turbine section.

The exhaust diffuser typically includes an inner liner and an outer barrel that is radially separated from the inner liner to form an exhaust flow passage through the exhaust diffuser. The exhaust flow passage contains and conveys heated exhaust gases that may be used for powering one or more bottoming cycles (such as generating steam for a steam turbine engine). Traditional exhaust diffusers are subject to high stresses due to operational vibrations and high temperatures of the exhaust gases.

As such, an improved insulation assembly for an exhaust diffuser that maintains the high temperatures of the exhaust gases and withstands the operational vibrations of the gas turbine is desired and would be advantageous in the art.

### SUMMARY

Aspects and advantages of the insulation assemblies and exhaust diffusers in accordance with the present disclosure will be set forth in part in the following description, or may be obvious from the description, or may be learned through practice of the technology.

In accordance with one embodiment, an insulation assembly is provided. The insulation assembly is affixed to a turbomachine component. The insulation assembly includes at least one pin that is fixedly coupled to the turbomachine component. The at least one pin includes a pin body and a disk that is coupled to the pin body. The insulation assembly further includes at least one washer that surrounds the pin body and is movable relative to the at least one pin. The at least one washer includes a disk body and a plurality of lobe members that extend from the disk body. The insulation assembly further includes an insulation panel that is disposed between the at least one washer and the turbomachine component. The insulation panel surrounds the pin body, and the insulation panel is movable between the at least one washer and the turbomachine component relative to the at least one pin and relative to the turbomachine component.

In accordance with another embodiment, an exhaust diffuser is provided. The exhaust diffuser includes an inner liner and an outer barrel. The outer barrel is spaced apart from the inner liner such that an exhaust flow passage is defined between the inner liner and the outer barrel. The exhaust diffuser further includes an insulation assembly affixed to an exterior surface of the outer barrel. The insulation assembly includes at least one pin that is fixedly coupled to the outer barrel. The at least one pin includes a pin body and a disk that is coupled to the pin body. The insulation assembly further includes at least one washer that surrounds the pin body and is movable relative to the at least one pin. The at least one washer includes a disk body and a plurality of lobe members that extend from the disk body. The insulation assembly further includes an insulation panel that is disposed between the at least one washer and the outer barrel. The insulation panel surrounds the pin body, and the insulation panel is movable between the at least one washer and the outer barrel relative to the at least one pin and relative to the turbomachine component.

These and other features, aspects and advantages of the present insulation assemblies and exhaust diffusers will become better understood with reference to the following description and appended claims. The accompanying drawings, which are incorporated in and constitute a part of this specification, illustrate embodiments of the technology and, together with the description, explain the principles of the technology.

### BRIEF DESCRIPTION OF THE DRAWINGS

A full and enabling disclosure of the present insulation assemblies and exhaust diffusers, including the best mode of making and using the present systems and methods, directed to one of ordinary skill in the art, is set forth in the specification, which refers to the appended figures, in which:

FIG. 1 is a schematic illustration of a turbomachine in accordance with embodiments of the present disclosure;

FIG. 2 illustrates an enlarged cross-sectional view of an exhaust diffuser in accordance with embodiments of the present disclosure;

FIG. 3 illustrates a perspective view of a turbomachine component, which in the depicted embodiment is an outer barrel of an exhaust diffuser, in accordance with embodiments of the present disclosure;

FIG. 4 illustrates an enlarged view of the detail outlined in FIG. 3 in accordance with exemplary aspects of the present disclosure;

FIG. 5 illustrates a perspective view of at least one washer of an insulation assembly in accordance with exemplary aspects of the present disclosure;

FIG. 6 illustrates a cross-sectional view of the insulation assembly shown in FIG. 4 from along the line 6-6 in accordance with embodiments of the present disclosure; and,

FIG. 7 illustrates a cross-sectional view of the insulation assembly from FIG. 6 that is experiencing an outside force, which causes movement of an insulation panel relative to a pin in accordance with exemplary aspects of the present disclosure.

### DETAILED DESCRIPTION OF THE INVENTION

Reference now will be made in detail to embodiments of the present insulation assemblies and exhaust diffusers, one or more examples of which are illustrated in the drawings. Each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

The detailed description uses numerical and letter designations to refer to features in the drawings. Like or similar designations in the drawings and description have been used to refer to like or similar parts of the invention. As used herein, the terms “first”, “second”, and “third” may be used interchangeably to distinguish one component from another and are not intended to signify location or importance of the individual components.

The term “fluid” may be a gas or a liquid. The term “fluid communication” means that a fluid is capable of making the connection between the areas specified.

As used herein, the terms “upstream” (or “forward”) and “downstream” (or “aft”) refer to the relative direction with respect to fluid flow in a fluid pathway. For example, “upstream” refers to the direction from which the fluid flows, and “downstream” refers to the direction to which the fluid flows. However, the terms “upstream” and “downstream” as used herein may also refer to a flow of electricity. The term “radially” refers to the relative direction that is substantially perpendicular to an axial centerline of a particular component, the term “axially” refers to the relative direction that is substantially parallel and/or coaxially aligned to an axial centerline of a particular component and the term “circumferentially” refers to the relative direction that extends around the axial centerline of a particular component.

Terms of approximation, such as “about,” “approximately,” “generally,” and “substantially,” are not to be limited to the precise value specified. In at least some instances, the approximating language may correspond to the precision of an instrument for measuring the value, or the precision of the methods or machines for constructing or manufacturing the components and/or systems. In at least some instances, the approximating language may correspond to the precision of an instrument for measuring the value, or the precision of the methods or machines for constructing or manufacturing the components and/or systems. For example, the approximating language may refer to being within a 1, 2, 4, 5, 10, 15, or 20 percent margin in either individual values, range(s) of values and/or endpoints defining range(s) of values. When used in the context of an angle or direction, such terms include within ten degrees greater or less than the stated angle or direction. For example, “generally vertical” includes directions within ten degrees of vertical in any direction, e.g., clockwise or counter-clockwise.

The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

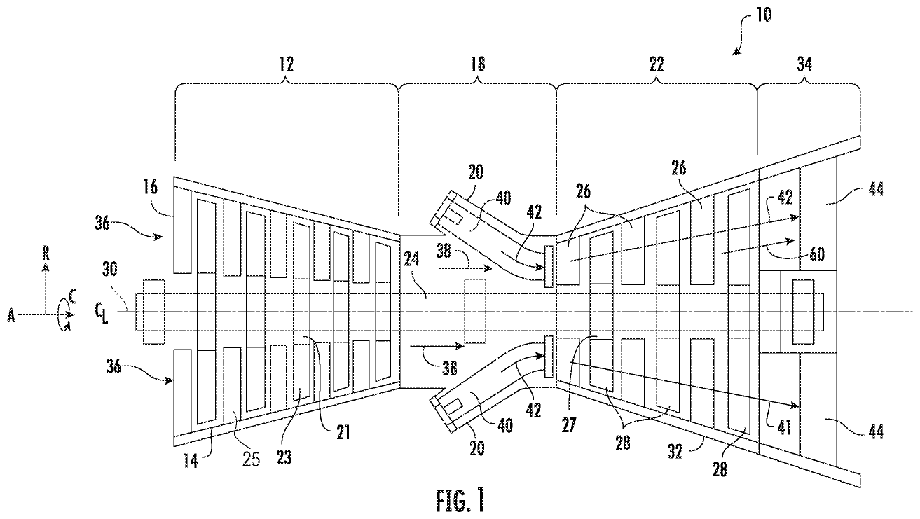

Referring now to the drawings, FIG. 1 illustrates a schematic diagram of one embodiment of a turbomachine, which in the illustrated embodiment is a gas turbine engine 10. Although an industrial or land-based gas turbine engine is shown and described herein, the present disclosure is not limited to an industrial and/or land-based gas turbine engine, unless otherwise specified in the claims. For example, the invention described herein may be used in any type of turbomachine including but not limited to a steam turbine, an aircraft gas turbine, or a marine gas turbine.

As shown, the gas turbine engine 10 generally includes a compressor section 12 The compressor section 12 includes a compressor 14. The compressor section 12 includes an inlet 16 that is disposed at an upstream end of the gas turbine engine 10. The gas turbine engine 10 further includes a combustion section 18 having one or more combustors 20 disposed downstream from the compressor section 12. The gas turbine engine 10 further includes a turbine section 22 (i.e., an expansion turbine section) that is downstream from the combustion section 18. A shaft 24 extends generally axially through the gas turbine engine 10.

The compressor section 12 may generally include a plurality of rotor disks 21 and a plurality of rotor blades 23 extending radially outwardly from and connected to each rotor disk 21. Each rotor disk 21 in turn may be coupled to or form an upstream portion of the shaft 24 that extends through the compressor section 12. The rotor blades 23 of the compressor section 12 may include turbomachine airfoils that define an airfoil shape (e.g., having a leading edge, a trailing edge, and side walls extending between the leading edge and the trailing edge). Additionally, the compressor section 12 includes stator vanes 25 disposed between the rotor blades 23 to define a series of compression stages. The stator vanes 25 may extend from, and couple to, a compressor casing.

The turbine section 22 may generally include a plurality of rotor disks 27 and a plurality of rotor blades 28 extending radially outwardly from and being interconnected to each rotor disk 27. Each rotor disk 27 in turn may be coupled to or form a downstream portion of the shaft 24 that extends through the turbine section 22. The turbine section 22 further includes an outer casing 32 that circumferentially surrounds the portion of the shaft 24 and the rotor blades 28. The turbine section 22 may include stationary nozzles 26 extending radially inward from the outer casing 32. The rotor blades 28 and stationary nozzles 26 may be arranged in alternating fashion in stages along an axial centerline 30 of gas turbine engine 10. Both the rotor blades 28 and the stationary nozzles 26 may include turbomachine airfoils that define an airfoil shape (e.g., having a leading edge, a trailing edge, and side walls extending between the leading edge and the trailing edge).

In operation, ambient air 36 or other working fluid is drawn into the inlet 16 of the compressor 14 and is progressively compressed to provide a compressed air 38 to the combustion section 18. The compressed air 38 flows into the combustion section 18 and is mixed with fuel to form a combustible mixture. The combustible mixture is burned within a combustion chamber 40 of the combustor 20, thereby generating combustion gases 42 that flow from the combustion chamber 40 into the turbine section 22. Energy (kinetic and/or thermal) is transferred from the combustion gases 42 to the rotor blades 28, causing the shaft 24 to rotate and produce mechanical work.

The gas turbine engine 10 may define a cylindrical coordinate system having an axial direction A extending along the axial centerline 30, a radial direction R perpendicular to the axial centerline 30, and a circumferential direction C extending around the axial centerline 30.

The combustion gases 42 exit the turbine section 22 and flow through the exhaust diffuser 34 across a plurality of struts 44 that are disposed within the exhaust diffuser 34. During various operating conditions of the gas turbine engine 10, such as during part-load operation, the combustion gases 42 flowing into the exhaust diffuser 34 from the turbine section 22 are conferred with a high level of swirl that is caused by the rotating turbine rotor blades 28. Such swirling flow can cause pressure fluctuations, frequency oscillations, or acoustic vibrations.

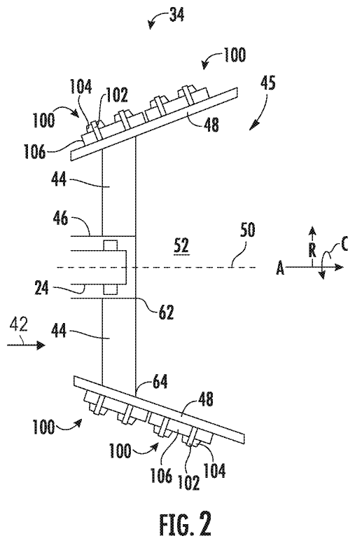

FIG. 2 illustrates a cross-sectional view of an exhaust diffuser 34 in accordance with embodiments of the present disclosure. As shown, the exhaust diffuser 34 generally includes an inner liner 46 and an outer barrel 48 radially spaced apart from the inner liner 46. The inner liner 46 may extend generally axially along an axial centerline 50 of the exhaust diffuser 34. The axial centerline 50 of the exhaust diffuser 34 may be coaxial with the axial centerline 30 of the gas turbine engine 10. The inner liner 46 is generally annular shaped and may at least partially surround rotating components. For example, the inner liner 46 may surround or encase a portion of the shaft 24 and/or one or more bearings.

In many embodiments, the outer barrel 48 may be radially separated from the inner liner 46, such that an exhaust flow passage 52 is defined between the inner liner 46 and the outer barrel 48. In particular embodiments, the inner liner 46 is concentrically and coaxially aligned within the outer barrel 48 with respect to the axial centerline 50. The present disclosure is not limited to any particular size, shape, material, or other physical characteristics of the inner liner 46 and/or the outer barrel 48 except as recited in the claims.

Each of the diffuser struts 44 may extend between the inner liner 46 and the outer barrel 48 and within the exhaust flow passage 52 defined therebetween. The diffuser struts 44 are spaced circumferentially around the inner liner 46, and the diffuser struts 44 may orient, align, or otherwise center the inner liner 46 within the outer barrel 48. In addition, the diffuser struts 44 may provide structural support between the inner liner 46 and the outer barrel 48. As shown in FIG. 1, the diffuser struts 44 are positioned relative to a direction of flow 60 of the spent combustion gases 42 flowing from the turbine section 22 of the gas turbine engine 10. As shown in FIG. 2, each diffuser strut 44 generally includes a root portion 62 that is connected to the inner liner 46 and a tip portion 64 radially separated from the root portion 62 and connected to the outer barrel 48.

In exemplary embodiments, the exhaust diffuser 34 may further include an insulation assembly 100 affixed to an outer surface of the outer barrel 48. The insulation assembly 100 may include at least one pin 102 fixedly coupled to the outer barrel 48. For example, the at least one pin 102 may be metallurgically bonded to the outer surface of the outer barrel 48 (such as welded, brazed, etc.). The insulation assembly 100 may further include at least one washer 104 surrounding the pin 102 and an insulation panel 106 disposed between the washer 104 and the outer barrel 48. For example, in the illustrated embodiment, one washer 104 surrounds the pin 102. However, in other embodiments, several washers 104 may surround the pin 102 in a stack. The insulation panel 106 may advantageously insulate the exhaust diffuser 34 such that the exhaust gases 42 traveling through the exhaust flow passage 52 maintain high temperatures, which may be advantageous for powering one or more bottoming cycles (such as a steam turbine or other secondary power generation machine). Specifically, as shown, the exhaust diffuser 34 may include a plurality of insulation assemblies 100 spaced apart from one another and each including an insulation panel 106 connected to an outer surface of the outer barrel 48 via a plurality of pins 102 and washers 104.

Referring now to FIG. 3, a perspective view of a turbomachine component 108 is illustrated in accordance with embodiments of the present disclosure. In various embodiments, the turbomachine component 108 may a compressor section component (such as a compressor rotor blade, a compressor stator vane, a compressor casing, or other compressor section components), a combustion section component (such as a combustion liner, an outer sleeve, a fuel nozzle, or other combustion section component), a turbine section component (such as a turbine rotor blade, a turbine stator nozzle, a turbine casing, or other turbine section components), or an exhaust section component (such as an inner liner, an outer barrel, a diffuser strut, or other exhaust section component). In exemplary embodiments, as depicted in FIG. 3, the turbomachine component 108 is an outer barrel 48 of an exhaust diffuser 34.

As shown, the outer barrel 48 may extend (e.g., axially) along the axial centerline 50 from a forward end 110 to an aft end 112. In some embodiments, the outer barrel 48 may be made in two halves (e.g., an upper half 111 and a lower half 113) that are joined to one another at split lines 115. The outer barrel 108 may define an inner surface 114 (which may partially define the exhaust flow passage 52 as shown in FIG. 2) and an outer surface 116. A plurality of insulation assemblies 100 may be affixed or connected to the outer surface 116 of the outer barrel 48. As shown, each insulation assembly 100 may include a plurality of pins 102 that couple an insulation panel 106 to the outer barrel 48. The plurality of insulation assemblies 100 may be spaced apart from one another both axially and circumferentially, such that the insulation assemblies 100 do not overlap one another.

Each insulation panel 106 may extend generally circumferentially between a first end and a second end. The plurality of pins 102 may be circumferentially (and/or axially) spaced apart from one another and positioned between the first end and the second end of the insulation panel 106. As shown in FIG. 3, the outer barrel may define a plurality of strut openings 118 that are circumferentially spaced apart from one another (e.g., equally spaced apart in many embodiments). One or more insulation assemblies 100 of the plurality of insulation assemblies 100 may be positioned between circumferentially neighboring strut openings 118. In locations along the curvature of the outer barrel 48 between strut openings 118 on the same half 111, 113 of the outer barrel 48, the insulation panels 106 are longest in the circumferential direction C, and the pins 102 may be located at corners of the insulation panels 106 and at one or more positions between the respective first and second ends. In locations between a strut opening 118 and a respective split line 115 of the outer barrel 48, the insulation panels 106 have varied dimensions as are practical to cover the outer surface 116, and the pins 102 may arranged in different patterns (e.g., in a triangular arrangement) to secure the respective insulation panel 106.

In various embodiments, the exhaust diffuser 34 may include a plurality of insulation assemblies 100 arranged in a plurality of axial rows 120, 122, 124, 126, 128 that are axially spaced apart from one another. For example, the insulation assemblies 100 may be arranged in a forward axial row 120 positioned proximate the forward end 110 of the exhaust diffuser, an aft axial row 128 positioned proximate the aft end 112 of the exhaust diffuser 34, and one or more intermediate axial rows 122, 124, 126 (e.g., three intermediate axial rows 122, 124, 126 in the depicted embodiment).

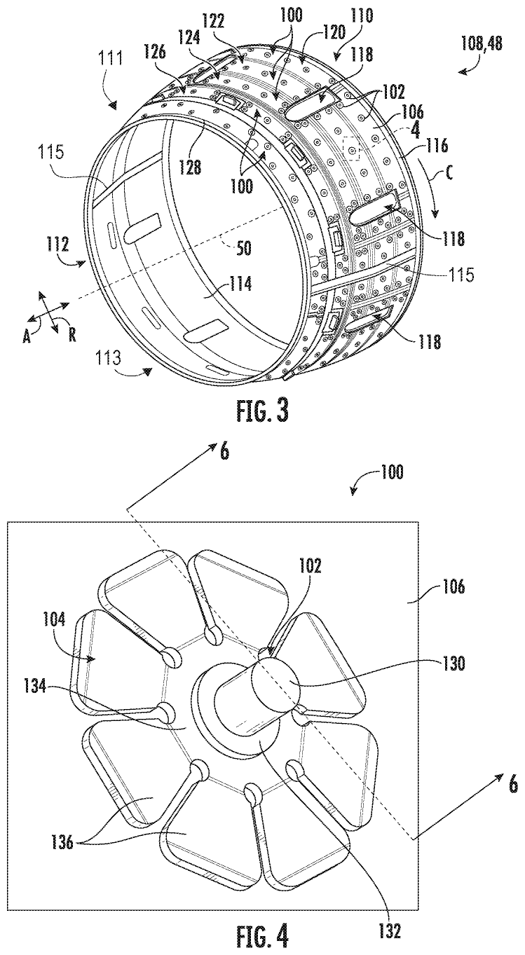

Referring now to FIG. 4, an enlarged view of the detail outlined in with a dashed line in FIG. 3 is illustrated in accordance with exemplary aspects of the present disclosure. As shown, the insulation assembly 100 includes the insulation panel 106, the pin 102, and the washer 104. The pin 102 may include a pin body 130 and a disk 132 fixedly connected to the pin body 130. The washer 104 surround the pin body 130 and is disposed between the disk 132 and the insulation panel 106. The washer 104 may include a central body 134 and a plurality of lobe members 136 extending outwardly from the central body 134.

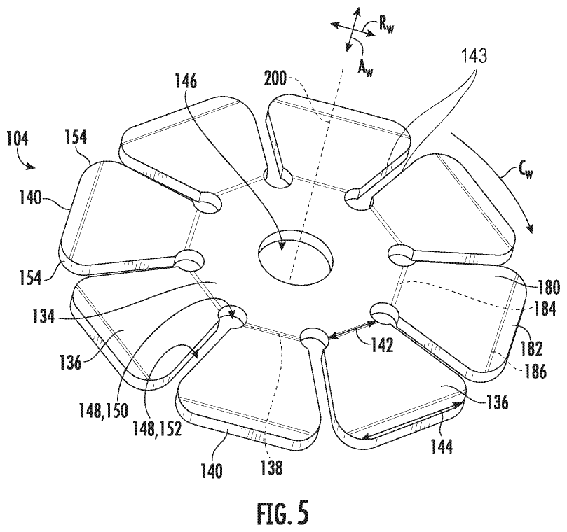

Referring now to FIG. 5, a perspective view of the washer 104 is illustrated in accordance with embodiments of the present disclosure. As shown, the washer 104 may extend along an axial centerline 200. A cylindrical coordinate system may be defined relative to the axial centerline 200 of the washer 104 that includes an axial direction A_{W} extending along the axial centerline 200, a radial direction R_{W} perpendicular to the axial centerline 200, and a circumferential direction C_{W} extending around the axial centerline 200.

As shown in FIG. 5, the washer 104 includes the central body 134 and the plurality of lobe members 136 extending outwardly (e.g., radially outwardly) from the disk body 134. Particularly, each lobe member 136 of the plurality of lobe members 136 may extend (e.g., radially) from a base 138 at the central body 134 to a tip 140. Additionally, as shown, each lobe member 136 of the plurality of lobe members 136 may include rounded edges 154 that extend to the tip 140. The plurality of lobe members 136 may be circumferentially spaced apart from one another with respect to the axial centerline 200 of the washer 104. Particularly, as shown, the plurality of lobe members 136 may be equally circumferentially spaced apart from one another. However, in other embodiments (not shown), the lobe members 136 may be unequally spaced apart from one another or may have different circumferential widths from one another at a common radius from the axial centerline 200.

Each of the lobe members 136 may generally increase in circumferential width as the lobe member 136 extends from the base 138 to the tip 140. That is, the radial edges 143 of each lobe member 136 may diverge from one another as the lobe member 138 extends radially from the base 138 to the tip 140. Specifically, as shown in FIG. 5, at least one of the lobe members 106 may define a first width 142 along the circumferential direction C_{W} at the base 138 and a second width 144 along the circumferential direction C_{W} at the tip 140. The second width 144 may be larger than the first width 142 (such as between about 50% and about 150% larger, or such as between about 75% and about 125% larger).

As shown in FIG. 5, the washer 104 may define a center opening 146 positioned on the axial centerline 200 of the washer 104. That is, the center opening 146 may be generally circularly shaped and centered on the axial centerline 200. Referring back to FIG. 4, briefly, the pin body 134 may extend through the center opening 146 of the washer 104. As described in more detail below, the washer 104 may be movable along the pin body 130 relative to the pin 102 and the insulation panel 106.

As shown in FIG. 5, the washer 104 may define a plurality of radial openings 148 disposed between the radial edges 143 of adjacent lobe members 136 of the plurality of lobe members 136. The plurality of radial openings 148 may be circumferentially spaced apart (e.g., equally or unequally). At least one (or each of, in many embodiments) of the radial openings 148 may include an aperture 150 (which may be circularly shaped) and a slot 152 extending (generally radially) from the aperture 150. For example, the aperture 150 may be disposed at least partially at the central body 134 of the washer 104, and the slot 152 may extend (e.g., radially) from the aperture 150 to the tip 140 of the at least one lobe member 106. The aperture 150 may be circumferentially larger than the slot 152 to mitigate stress on the washer 104 and/or the respective lobe members 136. Additionally, the slot 152 may be elongated (i.e., longest) in the radial direction R_{W}.

Additionally, as shown in FIG. 5, the lobe members 136 may each include a body portion 180 and a tip portion 182. The body portion 180 of each lobe member 136 may extend radially from the central body 134 to the tip portion 182 and circumferentially between the radial edges 143. The tip portion 182 may extend from the body portion 180 to the tip 140. The lobe members 136 may be angled (or bent) in two locations. Specifically, the body portion 180 of each lobe member 136 may be angled relative to the central body 146 at a first bend line 184. The first bend line 184 may be positioned at the base 138 of the lobe member 136. Further, the tip portion 182 may be angled relative to the body portion 180 at a second bend line 186. The tip portion 182 and the central body 134 may be generally parallel to one another. The second bend line 186 and the angle of the tip portion 182 relative to the body portion 180 may advantageously provide for an increased surface area contact between the insulation panel 106 and the tip portion 182 of the lobe members 136.

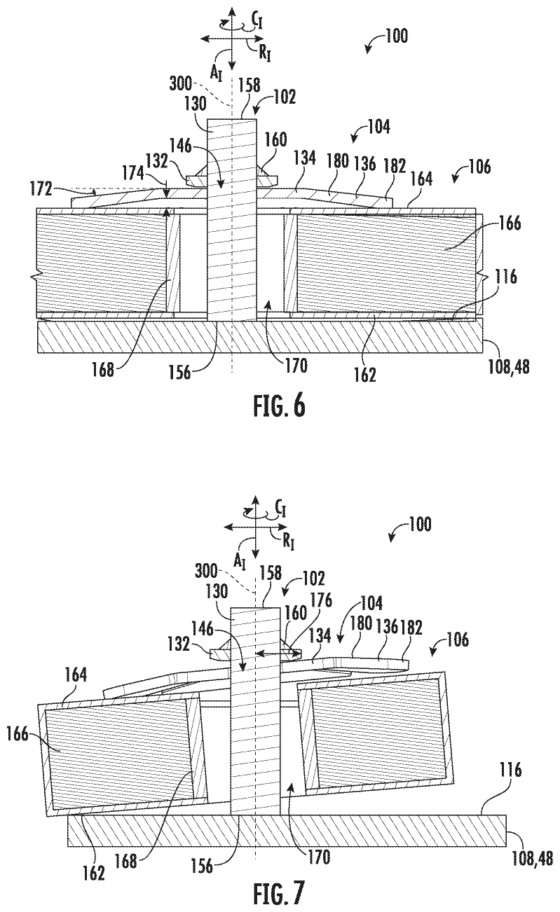

Referring now to FIGS. 6 and 7, two cross-sectional views of the insulation assembly 100 are illustrated in accordance with embodiments of the present disclosure. Specifically, FIG. 6 illustrates a cross-sectional view of the insulation assembly 100 shown in FIG. 4 from along the line 6-6. FIG. 7 illustrates a cross-sectional view of the insulation assembly 100 that is experiencing an outside force, which causes movement of the insulation panel 106 relative to the pin 102 and the turbomachine component 108.

As shown, the pin 102 includes the pin body 130 coupled to the turbomachine component 108 (e.g., coupled to an outer surface 116 of the outer barrel 48). For example, the pin body 130 may extend along a longitudinal centerline 300 from a root 156 coupled to the outer surface 116 of the outer barrel 48 to a terminal end 158. The insulation assembly 100 may define a cylindrical coordinate system that is defined relative to the longitudinal centerline 300 of the pin body 130 and that includes an axial direction A_{I} extending along the longitudinal centerline 300, a radial direction R_{I} perpendicular to the longitudinal centerline 300, and a circumferential direction C_{I} extending around the longitudinal centerline 300.

The pin body 130 may be generally cylindrically shaped, although the pin body 130 may have other shapes. The root 156 of the pin body 130 may be fixedly coupled to the outer surface 116 of the outer barrel via a metallurgical bond (such as welding or brazing). The pin 102 may further include the disk 132 that annularly surrounds the pin body 130. The disk 132 may be disposed closer to the terminal end 158 than the root 156 of the pin 102. The disk 132 may be coupled to the pin body 130 between the root 156 and the terminal end 158, after the insulation panel 106 and washer 104 are positioned over the pin body 130. In various embodiments, the disk 132 may be fixedly coupled (such as metallurgically bonded or joined) to the pin body 130 via welding, such that a weld seam or fillet 160 is defined annularly around the pin body 112, thereby permanently joining the pin body 130 to the disk 130. The weld seam or fillet 160 may have a generally wedge shape (or triangularly shaped) cross section that annularly surrounds the pin body 130.

As shown in FIGS. 6 and 7, the washer 104 surrounds the pin body 130 and is movable relative to the pin 102. More specifically, the washer 104 defines the center opening 146, and the pin body 130 extends through the center opening 146 such that the washer 104 is movable (e.g., axially) along the pin body 130. As described above, the washer 104 includes the central body 134 and the plurality of lobe members 136 extending from the central body 136. Specifically, the central body 134 may extend radially between the center opening 146 and the plurality of lobe members 136.

The insulation panel 106 may be disposed between (e.g., axially between, relative to axis 300) the washer 104 and the outer barrel 48. The insulation panel 106 may surround the pin body 130, and the insulation panel 106 may be movable between the washer 104 and the outer barrel 48 relative to the at least one pin 102 and relative to the outer barrel 48. In other words, while the pin 102 and the washer 104 couple the insulation panel 106 to the outer barrel 48, the insulation panel 106 is still capable of slight movements relative to the pin 102, the washer 104, and the outer barrel 48 to counteract vibrations experienced by the outer barrel 48 as a result of operation of the gas turbine engine 10.

The insulation panel 106 may include an inner plate 162, an outer plate 164, and insulating material 166 disposed between the inner plate 162 and the outer plate 164. The insulating material 166 may be a material that resists the transfer of heat and/or sound, which advantageously maintains high temperatures of exhaust gases within the exhaust diffuser 34 and/or minimizes sound. For example, the insulating material 166 may be a ceramic wool or glass wool in various embodiments. The inner plate 162 may contact the outer barrel 48, and the outer plate 164 may contact the washer 104. Specifically, the inner plate 162 may contact the outer surface 116 of the outer barrel 48, and the outer plate 164 may contact the plurality of lobe members 136 of the washer 104 (e.g., along the tip portions 182).

Additionally, the insulation panel 106 may further include a tube 168 that extends between the inner plate 162 and the outer plate 164. The tube 168 may define a channel 170 through which the pin body 130 is positioned. In other words, the pin body 130 may extend through the channel 170 of the tube 168. In many embodiments, a diameter of the channel 170 may be larger than a diameter of the pin body 130, such that the tube 168 is radially spaced apart from the pin body 130. This advantageously allows for the insulation panel 106 to move slightly in the radial direction R_{I}, which counteracts vibrational forces experienced by the outer barrel 48.

As shown in FIG. 6, the plurality of lobe members 136 may be angled relative to the central body 134 such that: (1) the plurality of lobe members 136 contact the insulation panel 106 (e.g., along the angled tip portions 182); and (2) the central body 134 is spaced apart from the insulation panel 106 and contacts the disk 132. That is, an inner surface of the plurality of lobe members 136 may each contact the outer plate 164 of the insulation panel 106, and an outer surface of the central body 134 of the washer 104 may contact the disk 132 of the pin 102.

In many embodiments, an angle 172 may be defined at the bend line 184 (FIG. 5) between the plurality of lobe members 136 and the central body 134 of the washer 104. The angle 172 may be between about 1° and about 45°, or between about 5° and about 30°, or such as between about 5° and about 20°. In other words, the central body 134 of the washer 104 may be oriented generally radially (e.g., in the radial direction R_{I}), and the plurality of lobes 136 may be angled relative to the radial direction R_{I}.

As shown in FIG. 6, the central body 134 of the washer 104 may be spaced apart (e.g., axially) from the insulation panel 106 such that a gap 174 (e.g., an axial gap) is defined between the insulation panel 106 and the central body 134 of the washer 104. Specifically, the gap 174 may be defined between an outer surface of the outer plate 164 of the insulation panel 106 and an inner surface of the central body 134 of the washer 104. In various embodiments, the gap 174 may be between about 0.025 inches and about 0.2 inches, or such as between about 0.05 inches and about 0.15 inches, or such as about 0.1 inches.

As shown in FIG. 7, the insulation assembly 100 may experience an outside force (such as vibration of the outer barrel 48 caused by operation of the gas turbine engine 10) that causes movement of the insulation panel 106 relative to the pin 102 and the turbomachine component 108. As shown, the washer 104 may be tiltable relative to the pin body 130. For example, the diameter of the center opening 146 may be slightly larger than the diameter of the pin body 130 (e.g., between about 1% larger and about 20% larger, or between about 1% larger and about 10% larger, or between about 1% larger and about 5% larger), which allows for the washer 104 to tilt or rotate slightly relative to the pin 102 as shown. This advantageously allows for the washer 104 to accommodate small movements of the insulation panel 106 without bending or breaking.

Additionally, as shown, a radius 176 may be defined between the longitudinal axis 300 and a radially terminal end of the disk 132. The radius 176 of the disk 132 may be smaller than a radius of the washer 104 (and/or the radius of the tube 168). The radius 176 may advantageously be smaller than prior designs, which places less of a moment on the pin 102 when the insulation panel 106 moves or rotates as shown in FIG. 7. This favorably prolongs the life of the 102 by reducing stress exposure.

This written description uses examples to disclose the invention, including the best mode, and also to enable any person skilled in the art to practice the invention, including making and using any devices or systems and performing any incorporated methods. The patentable scope of the invention is defined by the claims and may include other examples that occur to those skilled in the art. Such other examples are intended to be within the scope of the claims if they include structural elements that do not differ from the literal language of the claims, or if they include equivalent structural elements with insubstantial differences from the literal language of the claims.

Further aspects of the invention are provided by the subject matter of the following clauses:
An insulation assembly affixed to a turbomachine component, the insulation assembly comprising: at least one pin fixedly coupled to the turbomachine component, the at least one pin having a pin body and a disk coupled to the pin body; at least one washer surrounding the pin body and movable relative to the at least one pin, the at least one washer having a central body and a plurality of lobe members extending from the central body; and an insulation panel disposed between the at least one washer and the turbomachine component, wherein the insulation panel surrounds the pin body, and wherein the insulation panel is movable between the at least one washer and the turbomachine component relative to the at least one pin and relative to the turbomachine component.
The insulation assembly as in any preceding clause, wherein the plurality of lobe members is angled relative to the central body such that: the plurality of lobe members contact the insulation panel; and the central body is spaced apart from the insulation panel and contacts the disk.
The insulation assembly as in any preceding clause, wherein the central body is spaced apart from the insulation panel such that a gap is defined therebetween, and wherein the gap is between about 0.025 inches and about 0.2 inches.
The insulation assembly as in any preceding clause, wherein at least one lobe member of the plurality of lobe members extends from a base at the central body to a tip.
The insulation assembly as in any preceding clause, wherein the at least one lobe member defines a first width at the base and a second width at the tip, and wherein the second width is larger than the first width.
The insulation assembly as in any preceding clause, wherein the at least one washer defines a center opening, and wherein the pin body extends through the center opening.
The insulation assembly as in any preceding clause, wherein the plurality of lobe members of the at least one washer is partially defined by radial edges of each lobe member, such that a plurality of radial openings is disposed between adjacent lobe members of the plurality of lobe members.
The insulation assembly as in any preceding clause, wherein at least one radial opening of the plurality of openings includes an aperture disposed at least partially at the central body and a slot extending from the aperture to the tip of the at least one lobe member.
The insulation assembly as in any preceding clause, wherein the insulation panel includes an inner plate that contacts the turbomachine component, an outer plate that contacts the at least one washer, and insulating material disposed between the inner plate and the outer plate.
The insulation assembly as in any preceding clause, wherein the insulation panel includes a tube extending between the inner plate and the outer plate, wherein the tube defines a channel, and wherein the pin body extends through the channel.
An exhaust diffuser comprising: an inner liner; an outer barrel spaced apart from the inner liner such that an exhaust flow passage is defined between the inner liner and the outer barrel; and an insulation assembly affixed to an exterior surface of the outer barrel, the insulation assembly comprising: at least one pin fixedly coupled to the outer barrel, the at least one pin having a pin body and a disk coupled to the pin body; at least one washer surrounding the pin body and movable relative to the at least one pin, the at least one washer having a central body and a plurality of lobe members extending from the central body; and an insulation panel disposed between the at least one washer and the outer barrel, wherein the insulation panel surrounds the pin body, and wherein the insulation panel is movable between the at least one washer and the outer barrel relative to the at least one pin and relative to the outer barrel.
The exhaust diffuser as in any preceding clause, wherein the plurality of lobe members is angled relative to the central body such that: the plurality of lobe members contacts the insulation panel; and the central body is spaced apart from the insulation panel and contacts the disk.
The exhaust diffuser as in any preceding clause, wherein the central body is spaced apart from the insulation panel such that a gap is defined therebetween, and wherein the gap is between about 0.025 inches and about 0.2 inches.
The exhaust diffuser as in any preceding clause, wherein at least one lobe member of the plurality of lobe members extends from a base at the central body to a tip.
The exhaust diffuser as in any preceding clause, wherein the at least one lobe member defines a first width at the base and a second width at the tip, and wherein the second width is larger than the first width.
The exhaust diffuser as in any preceding clause, wherein the at least one washer defines a center opening, and wherein the pin body extends through the center opening.
The exhaust diffuser as in any preceding clause, wherein the plurality of lobe members of the at least one washer is partially defined by radial edges of each lobe member, such that a plurality of radial openings is disposed between adjacent lobe members of the plurality of lobe members.
The exhaust diffuser as in any preceding clause, wherein at least one radial opening of the plurality of openings includes an aperture disposed at least partially at the central body and a slot extending from the aperture to the tip of the at least one lobe member.
The exhaust diffuser as in any preceding clause, wherein the insulation panel includes an inner plate that contacts the outer barrel, an outer plate that contacts the at least one washer, and insulating material disposed between the inner plate and the outer plate.
The exhaust diffuser as in any preceding clause, wherein the insulation panel includes a tube extending between the inner plate and the outer plate, wherein the tube defines a channel, and wherein the pin body extends through the channel.

What is claimed is:

1. An insulation assembly affixed to a turbomachine component, the insulation assembly comprising:
at least one pin fixedly coupled to the turbomachine component, the at least one pin having a pin body and a disk coupled to the pin body;
at least one washer surrounding the pin body and movable relative to the at least one pin, the at least one washer having a central body and a plurality of lobe members extending from the central body; and,
an insulation panel disposed between the at least one washer and the turbomachine component, wherein the insulation panel surrounds the pin body, and wherein the insulation panel is movable between the at least one washer and the turbomachine component relative to the at least one pin and relative to the turbomachine component.

2. The insulation assembly as in claim 1, wherein the plurality of lobe members is angled relative to the central body such that:
the plurality of lobe members contact the insulation panel; and,
the central body is spaced apart from the insulation panel and contacts the disk.

3. The insulation assembly as in claim 1, wherein the central body is spaced apart from the insulation panel such that a gap is defined therebetween, and wherein the gap is between about 0.025 inches and about 0.2 inches.

4. The insulation assembly as in claim 1, wherein at least one lobe member of the plurality of lobe members extends from a base at the central body to a tip.

5. The insulation assembly as in claim 4, wherein the at least one lobe member defines a first width at the base and a second width at the tip, and wherein the second width is larger than the first width.

6. The insulation assembly as in claim 1, wherein the at least one washer defines a center opening, and wherein the pin body extends through the center opening.

7. The insulation assembly as in claim 1, wherein the plurality of lobe members of the at least one washer is partially defined by radial edges of each lobe member, such that a plurality of radial openings is disposed between adjacent lobe members of the plurality of lobe members.

8. The insulation assembly as in claim 7, wherein at least one radial opening of the plurality of openings includes an aperture disposed at least partially at the central body and a slot extending from the aperture to the tip of the at least one lobe member.

9. The insulation assembly as in claim 1, wherein the insulation panel includes an inner plate that contacts the turbomachine component, an outer plate that contacts the at least one washer, and insulating material disposed between the inner plate and the outer plate.

10. The insulation assembly as in claim 9, wherein the insulation panel includes a tube extending between the inner plate and the outer plate, wherein the tube defines a channel, and wherein the pin body extends through the channel.

11. An exhaust diffuser comprising:
an inner liner;
an outer barrel spaced apart from the inner liner such that an exhaust flow passage is defined between the inner liner and the outer barrel; and
an insulation assembly affixed to an exterior surface of the outer barrel, the insulation assembly comprising:
at least one pin fixedly coupled to the outer barrel, the at least one pin having a pin body and a disk coupled to the pin body;
at least one washer surrounding the pin body and movable relative to the at least one pin, the at least one washer having a central body and a plurality of lobe members extending from the central body; and,
an insulation panel disposed between the at least one washer and the outer barrel, wherein the insulation panel surrounds the pin body, and wherein the insulation panel is movable between the at least one washer and the outer barrel relative to the at least one pin and relative to the outer barrel.

12. The exhaust diffuser as in claim 11, wherein the plurality of lobe members is angled relative to the central body such that:
the plurality of lobe members contact the insulation panel; and,
the central body is spaced apart from the insulation panel and contacts the disk.

13. The exhaust diffuser as in claim 11, wherein the central body is spaced apart from the insulation panel such that a gap is defined therebetween, and wherein the gap is between about 0.025 inches and about 0.2 inches.

14. The exhaust diffuser as in claim 11, wherein at least one lobe member of the plurality of lobe members extends from a base at the central body to a tip.

15. The exhaust diffuser as in claim 14, wherein the at least one lobe member defines a first width at the base and a second width at the tip, and wherein the second width is larger than the first width.

16. The exhaust diffuser as in claim 11, wherein the at least one washer defines a center opening, and wherein the pin body extends through the center opening.

17. The exhaust diffuser as in claim 11, wherein the plurality of lobe members of the at least one washer is partially defined by radial edges of each lobe member, such that a plurality of radial openings is disposed between adjacent lobe members of the plurality of lobe members.

18. The exhaust diffuser as in claim 17, wherein at least one radial opening of the plurality of openings includes an aperture disposed at least partially at the central body and a slot extending from the aperture to the tip of the at least one lobe member.

19. The exhaust diffuser as in claim 11, wherein the insulation panel includes an inner plate that contacts the outer barrel, an outer plate that contacts the at least one washer, and insulating material disposed between the inner plate and the outer plate.

20. The exhaust diffuser as in claim 19, wherein the insulation panel includes a tube extending between the inner plate and the outer plate, wherein the tube defines a channel, and wherein the pin body extends through the channel.
